(19) United States
(12) Patent Application Publication
(10) Pub. No.: US 2026/0088966 A1
(43) Pub. Date: Mar. 26, 2026

(54) OPEN RADIO ACCESS NETWORK SPLIT DYNAMIC TDD SCHEDULING

(71) Applicant: QUALCOMM Incorporated, San Diego, CA (US)

(72) Inventors: Akashnil ROY, Kolkata (IN); Subhanshu SAHU, Delhi (IN); Orod RAEESI, Espoo (FI); Samel CELEBI, West New York, NJ (US)

(21) Appl. No.: 18/893,730

(22) Filed: Sep. 23, 2024

(51) Int. Cl. H04L 5/14; H04L 27/26; H04W 8/22

(52) U.S. Cl. CPC H04L 5/1469; H04L 27/2605; H04W 8/22

(57) ABSTRACT

Methods, systems, and devices for wireless communications are described. A radio unit (RU) and a distributed unit (DU) may support a dynamic time division duplexing (TDD) pattern. The RU may receive, at a start of a frame and from the DU, an indication of a TDD pattern for a quantity of slots. The TDD pattern may include multiple conditions or parameters, including the quantity of slots, a pattern period, a quantity of downlink slots, a quantity of uplink slots, a quantity of uplink symbols, and a quantity of downlink symbols. The RU may communicate one or more downlink messages, one or more uplink messages, or both during one or more slots of the frame in accordance with the TDD pattern.

### FIELD OF TECHNOLOGY

The following relates to wireless communications, including open radio access network (ORAN) split dynamic time division duplexing (TDD) scheduling.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

In some wireless communications systems, such as open radio access network (ORAN) wireless communications systems, a distributed unit (DU) may indicate a time division duplexing (TDD) pattern to a radio unit (RU). For example, the DU may indicate the TDD pattern to the RU via a management plane or a control plane. Indication of the TDD pattern via the management plane may involve a network outage associated with deactivation and subsequent activation of multiple endpoints. Alternatively, indication of the TDD pattern via the control plane may involve communication of multiple indications per frame. For example, the DU may transmit multiple TDD patterns corresponding to different slot types (e.g., uplink, downlink, and special slots) in a frame.

Techniques described herein support indication of a TDD pattern by a DU at a beginning of a frame, where the indication includes both downlink and uplink slots. For example, the RU may receive the indication of the TDD pattern including a pattern period, a quantity of downlink slots, a quantity of uplink slots, a quantity of downlink symbols, and a quantity of uplink symbols. The DU and the RU may communicate during the frame according to the indicated TDD pattern. For example, the DU and the RU may communicate one or more downlink messages, one or more uplink messages, or both during one or more slots of the frame in accordance with the TDD pattern. As the indication of the TDD pattern includes quantities of downlink and uplink slots and symbols, the indication may support reduced overhead compared to the indications associated with respective slot types sent via the control plane. For example, the RU may determine the quantity of special slots and symbols using the parameters included in the indication. Additionally, the indication of the TDD pattern may support improved performance compared to the indications sent via the management plane, as indication of the TDD pattern described herein is unassociated with a network outage.

The systems, methods, and devices of this disclosure each have several innovative aspects, no single one of which is solely responsible for the desirable attributes disclosed herein.

A method for wireless communications by a RU is described. The method may include receiving, at a start of a frame and from a DU, an indication of a TDD pattern for a quantity of slots, the TDD pattern including the quantity of slots, a pattern period, a quantity of downlink slots, a quantity of uplink slots, a quantity of uplink symbols, and a quantity of downlink symbols and communicating one or more downlink messages, one or more uplink messages, or both during one or more slots of the frame in accordance with the TDD pattern.

A RU for wireless communications is described. The RU may include one or more memories storing processor executable code, and one or more processors coupled with the one or more memories. The one or more processors may individually or collectively be operable to execute the code to cause the RU to receive, at a start of a frame and from a DU, an indication of a TDD pattern for a quantity of slots, the TDD pattern including the quantity of slots, a pattern period, a quantity of downlink slots, a quantity of uplink slots, a quantity of uplink symbols, and a quantity of downlink symbols and communicate one or more downlink messages, one or more uplink messages, or both during one or more slots of the frame in accordance with the TDD pattern.

Another RU for wireless communications is described. The RU may include means for receiving, at a start of a frame and from a DU, an indication of a TDD pattern for a quantity of slots, the TDD pattern including the quantity of slots, a pattern period, a quantity of downlink slots, a quantity of uplink slots, a quantity of uplink symbols, and a quantity of downlink symbols and means for communicating one or more downlink messages, one or more uplink messages, or both during one or more slots of the frame in accordance with the TDD pattern.

A non-transitory computer-readable medium storing code for wireless communications is described. The code may include instructions executable by one or more processors to receive, at a start of a frame and from a DU, an indication of a TDD pattern for a quantity of slots, the TDD pattern including the quantity of slots, a pattern period, a quantity of downlink slots, a quantity of uplink slots, a quantity of uplink symbols, and a quantity of downlink symbols and communicate one or more downlink messages, one or more uplink messages, or both during one or more slots of the frame in accordance with the TDD pattern.

Some examples of the method, RUs, and non-transitory computer-readable medium described herein may further include operations, features, means, or instructions for transmitting a capability message indicative of a capability of the RU to receive the indication of the TDD pattern, where receiving the indication of the TDD pattern may be in accordance with transmitting the capability message.

In some examples of the method, RUs, and non-transitory computer-readable medium described herein, the quantity of slots includes a non-zero integer quantity of slots for which the TDD pattern may be applicable.

In some examples of the method, RUs, and non-transitory computer-readable medium described herein, the quantity of slots may be zero and the RU communicates in accordance with the TDD pattern until an updated TDD pattern may be received.

Some examples of the method, RUs, and non-transitory computer-readable medium described herein may further include operations, features, means, or instructions for receiving a second indication of a second TDD pattern for a second quantity of slots and communicating during one or more second slots in accordance with the second TDD pattern, where the second TDD pattern replaces the TDD pattern.

In some examples of the method, RUs, and non-transitory computer-readable medium described herein, the pattern period may be indicative of a second quantity of slots associated with a periodicity of the TDD pattern and the TDD pattern may be repeated after the second quantity of slots.

In some examples of the method, RUs, and non-transitory computer-readable medium described herein, the quantity of downlink slots includes a quantity of consecutive downlink slots and the quantity of uplink slots includes a quantity of consecutive uplink slots.

In some examples of the method, RUs, and non-transitory computer-readable medium described herein, the quantity of downlink symbols includes a quantity of consecutive downlink symbols in one or more special slots of the TDD pattern and the quantity of uplink symbols includes a quantity of consecutive uplink symbols in the one or more special slots of the TDD pattern.

Some examples of the method, RUs, and non-transitory computer-readable medium described herein may further include operations, features, means, or instructions for determining one or more special slots using the quantity of downlink slots and the quantity of uplink slots, where: the one or more special slots may be after the quantity of downlink slots and before the quantity of uplink slots in time; and communicating with the user equipment (UE) may be in accordance with the quantity of special slots.

Some examples of the method, RUs, and non-transitory computer-readable medium described herein may further include operations, features, means, or instructions for determining one or more guard symbols using the quantity of downlink symbols and the quantity of uplink symbols, where: the one or more guard symbols may be after the quantity of downlink symbols and before the quantity of uplink symbols in time; and communicating with the UE may be in accordance with the quantity of guard symbols.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports open radio access network (ORAN) split dynamic time division duplexing (TDD) scheduling in accordance with one or more aspects of the present disclosure.

FIG. 2 shows an example of a network architecture that supports ORAN split dynamic TDD scheduling in accordance with one or more aspects of the present disclosure.

FIG. 3 shows an example of a wireless communications system that supports ORAN split dynamic TDD scheduling in accordance with one or more aspects of the present disclosure.

FIG. 4 shows an example of a process flow that supports ORAN split dynamic TDD scheduling in accordance with one or more aspects of the present disclosure.

FIGS. 5 and 6 show block diagrams of devices that support ORAN split dynamic TDD scheduling in accordance with one or more aspects of the present disclosure.

FIG. 7 shows a block diagram of a communications manager that supports ORAN split dynamic TDD scheduling in accordance with one or more aspects of the present disclosure.

FIG. 8 shows a diagram of a system including a device that supports ORAN split dynamic TDD scheduling in accordance with one or more aspects of the present disclosure.

FIGS. 9 and 10 show flowcharts illustrating methods that support ORAN split dynamic TDD scheduling in accordance with one or more aspects of the present disclosure.

### DETAILED DESCRIPTION

In some wireless communications systems, such as open radio access network (ORAN) wireless communications systems, a distributed unit (DU) may indicate a time division duplexing (TDD) pattern to a radio unit (RU). In some cases, the DU may indicate a TDD pattern to the RU via a management plane (e.g., an M plane). For example, indication of the TDD pattern via the management plane may involve deactivating and activating multiple endpoints of the ORAN. That is, the DU may deactivate a first set of one or more endpoints associated with a first TDD pattern and activate a second set of one or more endpoints associated with a second TDD pattern (e.g., an updated TDD pattern) in order to update a TDD pattern (e.g., change the TDD pattern from the first TDD pattern to the second TDD pattern). However, such activation and deactivation may be associated with a network outage for a duration between deactivation of the first set of one or more endpoints and activation of the second set of one or more endpoints.

Alternatively, the DU may indicate a TDD pattern to the RU via a control plane (e.g., a C plane). In such cases, the DU may indicate a TDD pattern for one type of slot per indication. That is, the DU may indicate a TDD pattern including one of downlink slots, uplink slots, or special slots. As an example, to indicate a TDD pattern of two downlink slots, a special slot, and two uplink slots for a subcarrier spacing of 30 kHz, the DU may indicate a TDD pattern 12 times in a frame. That is, the DU may indicate the TDD pattern for the two downlink slots, the TDD pattern for the special slot, and the TDD pattern for the two uplink slots. The DU may repeat the indications for the downlink, special, and uplink TDD patterns four times in a frame. Indicating the TDD pattern for downlink, special, and uplink slots may be inefficient as the indication is sent multiple times in a frame, and the RU may determine the quantity of special slots using the quantity of uplink and downlink slots (e.g., without explicit indication).

Techniques described herein support indication of a TDD pattern by a DU at a beginning of a frame, where the indication includes both downlink and uplink slots. For example, the RU may receive the indication of the TDD pattern including a pattern period, a quantity of downlink slots, a quantity of uplink slots, a quantity of downlink symbols, and a quantity of uplink symbols. The indication of the TDD pattern may, in some examples, indicate more than one TDD pattern. That is, the indication may include sets of parameters (e.g., quantities of downlink and uplink symbols and slots) for multiple TDD patterns, where the RU may apply the multiple TDD patterns one after the other. In some examples, the indication of the TDD pattern may include an indication of a duration for which the indicated TDD pattern is applicable. For example, the DU may indicate that the TDD pattern is applicable for a quantity of slots or the DU may indicate that the TDD pattern is applicable until an updated TDD pattern is indicated (e.g., indefinitely). The DU and the RU may communicate during the frame according to the indicated TDD pattern. For example, the DU and the RU may communicate one or more downlink messages, one or more uplink messages, or both during one or more slots of the frame in accordance with the TDD pattern.

Aspects of the disclosure are initially described in the context of wireless communications systems. Aspects of the disclosure are further described in the context of network architecture diagrams and process flows. Aspects of the disclosure are further illustrated by and described with reference to apparatus diagrams, system diagrams, and flowcharts that relate to ORAN split dynamic TDD scheduling.

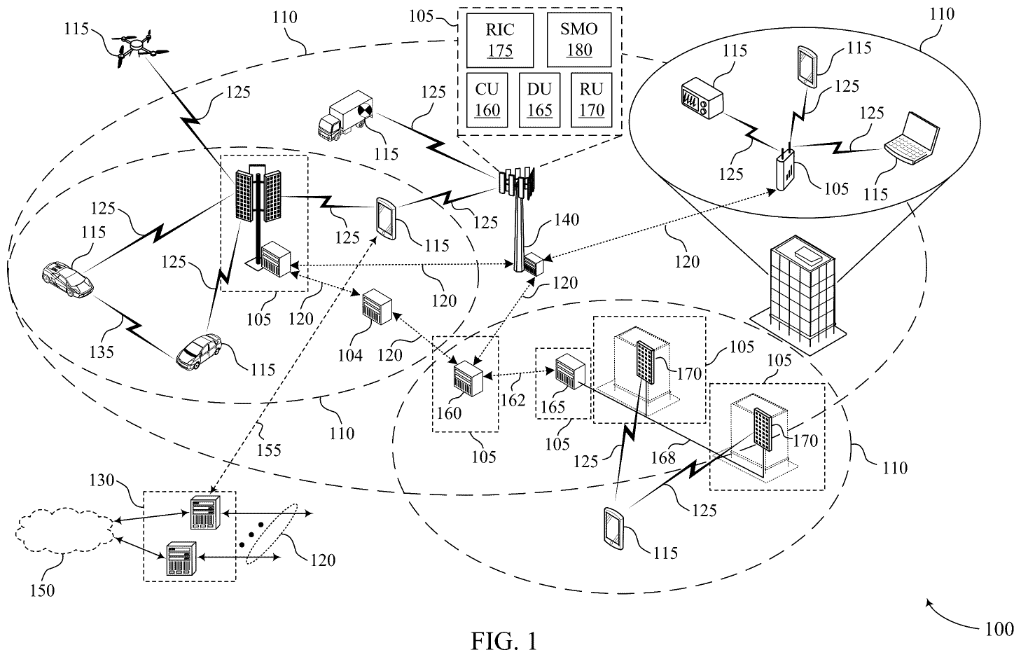

FIG. 1 shows an example of a wireless communications system 100 that supports ORAN split dynamic TDD scheduling in accordance with one or more aspects of the present disclosure. The wireless communications system 100 may include one or more devices, such as one or more network devices (e.g., the network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, a network entity 105, apparatus, device, computing system, or the like may include disclosure of the UE 115, a network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a DU, such as a DU 165, an RU, such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote RU (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and TDD component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example, a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

Some wireless communications systems may support configuration of TDD patterns via RRC signaling. For example, the network entity 105 may indicate one or more TDD patterns to the UE 115 via one or more control messages, such as via RRC messages. The one or more control messages may indicate the TDD pattern by indicating a set of parameters including a quantity of downlink slots (e.g., nrofDownlinkSlots {0-80}), a quantity of downlink symbols (e.g., nrofDownlinkSymbols {0-13}), a quantity of uplink symbols (e.g., nrofUplinkSymbols {0-13}), and a quantity of uplink slots (e.g., nrofUplinkSlots {0-80}). Using the indicated set of parameters, the UE 115 may determine a quantity of flexible symbols. For example, the UE 115 may calculate the quantity of flexible symbols by subtracting a quantity of downlink symbols and a quantity of uplink symbols from a slot duration for the TDD pattern. In some examples, the UE 115 may obtain a total quantity of slots (e.g., a slot duration) for the TDD pattern in accordance with a reference subcarrier spacing (e.g., referenceSubcarrierSpacing) and a transmission periodicity (e.g., DL-UL-TransmissionPeriodicity {0.5-10}ms). The one or more control signals may indicate a first TDD pattern and a second TDD pattern (e.g., two patterns back-to-back), where the first TDD pattern and the second TDD pattern are used alternately. That is, the network entity 105 and the UE 115 may communicate according to the first TDD pattern followed by the second TDD pattern and, again, the first TDD pattern and so on. In some cases, UE-specific signaling may indicate slot formats which override one or more flexible symbols in a TDD pattern (e.g., a common TDD configuration). As an example, the UE 115 may receive one or more signals associated with the UE 115 (e.g., UE-specific signaling) that may override a set of one or more flexible symbols as uplink symbols or downlink symbols.

To update the TDD pattern, the network entity 105 may transmit one or more second control messages (e.g., RRC messages) to the UE 115. For example, the network entity 105 may transmit RRC message in advance of a frame such that a time of reception and execution of the TDD pattern by the UE 115 is known to the network entity 105. A frequency at which the TDD pattern is updated may be in accordance with usage of a cell of the network entity 105 and the UE 115. For example, during a first duration (e.g., at night) in which data is sent from the network entity to the UE 115 at a greater rate than data is sent from the UE 115 to the network entity 105 (e.g., relatively more downloads), the network entity 105 may update the TDD pattern to include more downlink slots. Alternatively, during a second duration (e.g., during the day) in which data is sent from the UE 115 to the network entity 105 at a greater rate than data is sent from the network entity 105 to the UE 115 (e.g., relatively more uploads), the network entity 105 may update the TDD pattern to include more uplink slots.

However, indication of the TDD pattern via RRC signaling may not be applicable to wireless communications systems involving an ORAN split. That is, a DU (e.g., an O-DU) and an RU (e.g., an O-RU) may not support configuration of or update to a TDD pattern via RRC signaling. In some cases, the DU may indicate a TDD pattern to the RU via a management plane (e.g., an M plane). For example, indication of the TDD pattern via the management plane may involve deactivating and activating multiple endpoints of the ORAN. That is, the DU may deactivate a first set of one or more endpoints associated with a first TDD pattern and activate a second set of one or more endpoints associated with a second TDD pattern (e.g., an updated TDD pattern) in order to update a TDD pattern (e.g., change the TDD pattern from the first TDD pattern to the second TDD pattern). However, such activation and deactivation may be associated with a network outage for a duration between deactivation of the first set of one or more endpoints and activation of the second set of one or more endpoints (e.g., an outage duration of approximately 5 minutes for 132 endpoints).

Alternatively, the DU may indicate a TDD pattern to the RU via a control plane (e.g., a C plane, such as a C plane section type 4 with stdcmdtype=2). In such cases, the DU may indicate a TDD pattern for one type of slot per indication. That is, the DU may indicate a TDD pattern including one of downlink slots, uplink slots, or special slots. As an example, to indicate a TDD pattern of two downlink slots, a special slot, and two uplink slots for a subcarrier spacing of 30 kHz, the DU may indicate a TDD pattern 12 times in a frame. That is, the DU may indicate the TDD pattern for the two downlink slots, the TDD pattern for the special slot, and the TDD pattern for the two uplink slots. The DU may repeat the indications for the downlink, special, and uplink TDD patterns four times in a frame. Indicating the TDD pattern for downlink, special, and uplink slots may be inefficient as the indication is sent multiple times in a frame, and the RU may determine the quantity of special slots using the quantity of uplink and downlink slots (e.g., without explicit indication).

Techniques described herein support indication of a TDD pattern by a network entity 105, such as a DU, at a beginning of a frame, where the indication includes both downlink and uplink slots. For example, a network entity 105, such as an RU, may receive, from the DU, the indication of the TDD pattern including a pattern period, a quantity of downlink slots, a quantity of uplink slots, a quantity of downlink symbols, and a quantity of uplink symbols. The indication of the TDD pattern may, in some examples, indicate more than one TDD pattern. That is, the indication may include sets of parameters (e.g., quantities of downlink and uplink symbols and slots) for multiple TDD patterns, where the RU may apply the multiple TDD patterns one after the other. In some examples, the indication of the TDD pattern may include an indication of a duration for which the indicated TDD pattern is applicable. For example, the DU may indicate that the TDD pattern is applicable for a quantity of slots, or, the DU may indicate that the TDD pattern is applicable until an updated TDD pattern is indicated (e.g., indefinitely). The DU and the RU may communicate during the frame according to the indicated TDD pattern. For example, the DU and the RU may communicate one or more downlink messages, one or more uplink messages, or both during one or more slots of the frame in accordance with the TDD pattern.

As the indication of the TDD pattern includes quantities of downlink and uplink slots and symbols, the indication may support reduced overhead compared to the indications associated with respective slot types sent via the control plane. As an example, for a TDD pattern including 7 downlink slots, a special slot, and 2 uplink slots for a subcarrier spacing of 30 kHz, the DU and the RU may communicate the TDD pattern indication 6 times in a frame. Such an example may be associated with 144 bytes, whereas transmitting the indication of the TDD pattern once may be associated with 28 bytes. Additionally, the indication of the TDD pattern may support improved performance compared to the indications sent via the management plane, as indication of the TDD pattern described herein is unassociated with a network outage.

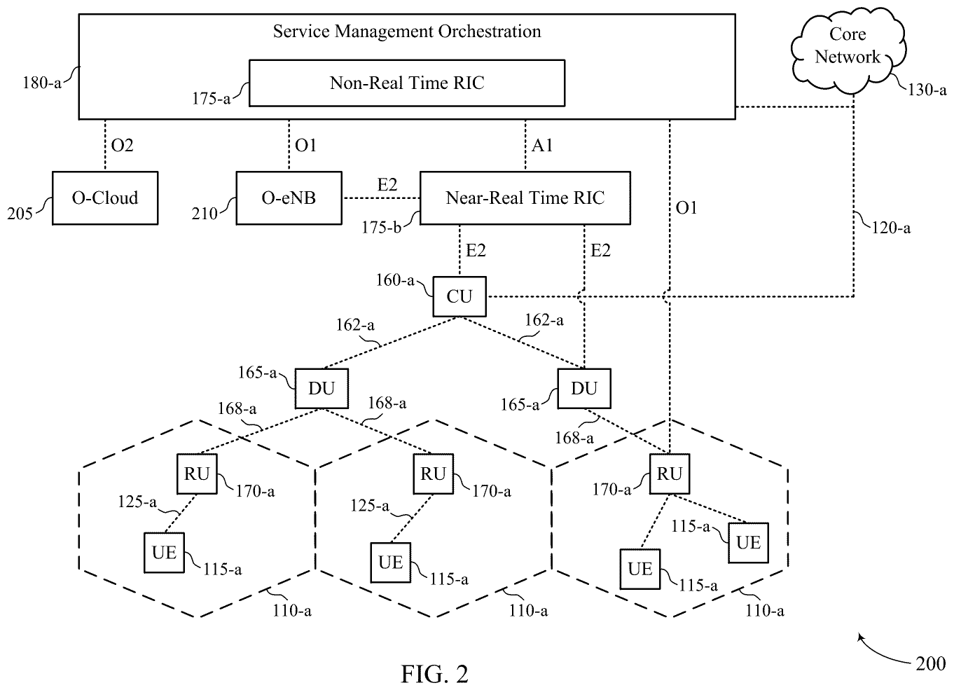

FIG. 2 shows an example of a network architecture 200 (e.g., a disaggregated base station architecture, a disaggregated RAN architecture) that supports ORAN split dynamic TDD scheduling in accordance with one or more aspects of the present disclosure. The network architecture 200 may illustrate an example for implementing one or more aspects of the wireless communications system 100. The network architecture 200 may include one or more CUs 160-a that may communicate directly with a core network 130-a via a backhaul communication link 120-a, or indirectly with the core network 130-a through one or more disaggregated network entities 105 (e.g., a Near-RT RIC 175-b via an E2 link, or a Non-RT RIC 175-a associated with an SMO 180-a (e.g., an SMO Framework), or both). A CU 160-a may communicate with one or more DUs 165-a via respective midhaul communication links 162-a (e.g., an F1 interface). The DUs 165-a may communicate with one or more RUs 170-a via respective fronthaul communication links 168-a. The RUs 170-a may be associated with respective coverage areas 110-a and may communicate with UEs 115-a via one or more communication links 125-a. In some implementations, a UE 115-a may be simultaneously served by multiple RUs 170-a.

Each of the network entities 105 of the network architecture 200 (e.g., CUs 160-a, DUs 165-a, RUs 170-a, Non-RT RICs 175-a, Near-RT RICs 175-b, SMOs 180-a, Open Clouds (O-Clouds) 205, Open eNBs (O-eNBs) 210) may include one or more interfaces or may be coupled with one or more interfaces configured to receive or transmit signals (e.g., data, information) via a wired or wireless transmission medium. Each network entity 105, or an associated processor (e.g., controller) providing instructions to an interface of the network entity 105, may be configured to communicate with one or more of the other network entities 105 via the transmission medium. For example, the network entities 105 may include a wired interface configured to receive or transmit signals over a wired transmission medium to one or more of the other network entities 105. Additionally, or alternatively, the network entities 105 may include a wireless interface, which may include a receiver, a transmitter, or transceiver (e.g., an RF transceiver) configured to receive or transmit signals, or both, over a wireless transmission medium to one or more of the other network entities 105.

In some examples, a CU 160-a may host one or more higher layer control functions. Such control functions may include RRC, PDCP, SDAP, or the like. Each control function may be implemented with an interface configured to communicate signals with other control functions hosted by the CU 160-a. A CU 160-a may be configured to handle user plane functionality (e.g., CU-UP), control plane functionality (e.g., CU-CP), or a combination thereof. In some examples, a CU 160-a may be logically split into one or more CU-UP units and one or more CU-CP units. A CU-UP unit may communicate bidirectionally with the CU-CP unit via an interface, such as an E1 interface when implemented in an O-RAN configuration. A CU 160-a may be implemented to communicate with a DU 165-a, as necessary, for network control and signaling.

A DU 165-a may correspond to a logical unit that includes one or more functions (e.g., base station functions, RAN functions) to control the operation of one or more RUs 170-a. In some examples, a DU 165-a may host, at least partially, one or more of an RLC layer, a MAC layer, and one or more aspects of a PHY layer (e.g., a high PHY layer, such as modules for FEC encoding and decoding, scrambling, modulation and demodulation, or the like) depending, at least in part, on a functional split, such as those defined by the 3rd Generation Partnership Project (3GPP). In some examples, a DU 165-a may further host one or more low PHY layers. Each layer may be implemented with an interface configured to communicate signals with other layers hosted by the DU 165-a, or with control functions hosted by a CU 160-a.

In some examples, lower-layer functionality may be implemented by one or more RUs 170-a. For example, an RU 170-a, controlled by a DU 165-a, may correspond to a logical node that hosts RF processing functions, or low-PHY layer functions (e.g., performing fast Fourier transform (FFT), inverse FFT (iFFT), digital beamforming, physical random access channel (PRACH) extraction and filtering, or the like), or both, based at least in part on the functional split, such as a lower-layer functional split. In such an architecture, an RU 170-a may be implemented to handle over the air (OTA) communication with one or more UEs 115-a. In some implementations, real-time and non-real-time aspects of control and user plane communication with the RU(s) 170-a may be controlled by the corresponding DU 165-a. In some examples, such a configuration may enable a DU 165-a and a CU 160-a to be implemented in a cloud-based RAN architecture, such as a vRAN architecture.

The SMO 180-a may be configured to support RAN deployment and provisioning of non-virtualized and virtualized network entities 105. For non-virtualized network entities 105, the SMO 180-a may be configured to support the deployment of dedicated physical resources for RAN coverage requirements which may be managed via an operations and maintenance interface (e.g., an O1 interface). For virtualized network entities 105, the SMO 180-a may be configured to interact with a cloud computing platform (e.g., an O-Cloud 205) to perform network entity life cycle management (e.g., to instantiate virtualized network entities 105) via a cloud computing platform interface (e.g., an O2 interface). Such virtualized network entities 105 can include, but are not limited to, CUs 160-a, DUs 165-a, RUs 170-a, and Near-RT RICs 175-b. In some implementations, the SMO 180-a may communicate with components configured in accordance with a 4G RAN (e.g., via an O1 interface). Additionally, or alternatively, in some implementations, the SMO 180-a may communicate directly with one or more RUs 170-a via an O1 interface. The SMO 180-a also may include a Non-RT RIC 175-a configured to support functionality of the SMO 180-a.

The Non-RT RIC 175-a may be configured to include a logical function that enables non-real-time control and optimization of RAN elements and resources, Artificial Intelligence (AI) or Machine Learning (ML) workflows including model training and updates, or policy-based guidance of applications/features in the Near-RT RIC 175-b. The Non-RT RIC 175-a may be coupled to or communicate with (e.g., via an A1 interface) the Near-RT RIC 175-b. The Near-RT RIC 175-b may be configured to include a logical function that enables near-real-time control and optimization of RAN elements and resources via data collection and actions over an interface (e.g., via an E2 interface) connecting one or more CUs 160-a, one or more DUs 165-a, or both, as well as an O-eNB 210, with the Near-RT RIC 175-b.

In some examples, to generate AI/ML models to be deployed in the Near-RT RIC 175-b, the Non-RT RIC 175-a may receive parameters or external enrichment information from external servers. Such information may be utilized by the Near-RT RIC 175-b and may be received at the SMO 180-a or the Non-RT RIC 175-a from non-network data sources or from network functions. In some examples, the Non-RT RIC 175-a or the Near-RT RIC 175-b may be configured to tune RAN behavior or performance. For example, the Non-RT RIC 175-a may monitor long-term trends and patterns for performance and employ AI or ML models to perform corrective actions through the SMO 180-a (e.g., reconfiguration via O1) or via generation of RAN management policies (e.g., A1 policies).

In the network architecture 200, the DU 165 may indicate a TDD pattern to the RU 170. For example, the DU 165 may indicate the TDD pattern to the RU 170 via a management plane or a control plane. Indication of the TDD pattern via the management plane may involve a network outage associated with deactivation and subsequent activation of multiple endpoints. Alternatively, indication of the TDD pattern via the control plane may involve communication of multiple indications per frame. For example, the DU 165 may transmit multiple TDD patterns corresponding to different slot types (e.g., uplink, downlink, and special slots) in a frame.

Techniques described herein support indication of a TDD pattern by a DU 165 at a beginning of a frame, where the indication includes both downlink and uplink slots. For example, the RU 170 may receive the indication of the TDD pattern including a pattern period, a quantity of downlink slots, a quantity of uplink slots, a quantity of downlink symbols, and a quantity of uplink symbols. The DU 165 and the RU 170 may communicate during the frame according to the indicated TDD pattern. For example, the DU 165 and the RU 170 may communicate one or more downlink messages, one or more uplink messages, or both during one or more slots of the frame in accordance with the TDD pattern. As the indication of the TDD pattern includes quantities of downlink and uplink slots and symbols, the indication may support reduced overhead compared to the indications associated with respective slot types sent via the control plane. For example, the RU 170 may determine the quantity of special slots and symbols using the parameters included in the indication. Additionally, the indication of the TDD pattern may support improved performance compared to the indications sent via the management plane, as indication of the TDD pattern described herein is unassociated with a network outage.

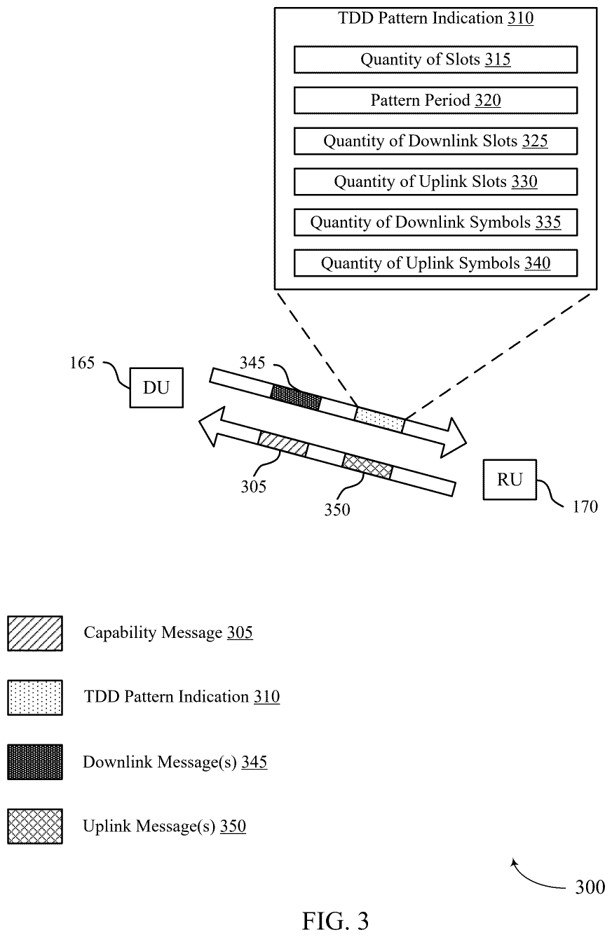

FIG. 3 shows an example of a wireless communications system 300 that supports ORAN split dynamic TDD scheduling in accordance with one or more aspects of the present disclosure. The wireless communications system 300 may implement or be implemented by various aspects of the wireless communications system 100, the network architecture 200, or both. For example, the wireless communications system 300 may include a DU 165 and an RU 170, which may represent examples of corresponding devices as described with reference to FIG. 2.

The DU 165 and the RU 170 may support dynamic TDD patterns. For example, the DU 165 and the RU 170 may support a section command type that indicates dynamic TDD patterns (e.g., section type 4, section command type 5). For example, the DU 165 may transmit a TDD pattern indication 310 to the RU 170 at a start of a frame. In some examples, the DU 165 may transmit the TDD pattern indication 310 to the RU 170 based on a capability of the RU 170 to support dynamic TDD patterns. For example, the RU 170 may transmit a capability message 305 indicative of a capability of the RU 170 to receive the TDD pattern indication 310. That is, the capability message 305 may indicate a capability of the RU 170 to receive a section command of the section command type (e.g., section type 4, section command type 5 or a dynamic TDD pattern command). The RU 170 may transmit the capability message via a management plane. In some examples, the RU 170 may set a field corresponding to dynamic TDD capability (e.g., dynamic tdd_st4) to ‘true’ to indicate the capability. That is, the capability message 305 may include the field corresponding to the dynamic TDD capability, where a value in the field is indicative of whether the RU 170 supports dynamic TDD patterns.

The TDD pattern indication 310 may include a set of one or more parameters. For example, the set of one or more parameters may define the TDD pattern by indicating quantities of downlink and uplink slots and symbols and a period of the pattern. That is, the TDD pattern indication 310 may include a quantity of slots 315, a pattern period 320, a quantity of downlink slots 325, a quantity of uplink slots 330, a quantity of downlink symbols 335, and a quantity of uplink symbols 340. In some examples, the DU 165 may determine each parameter of the set of one or more parameters that define the TDD pattern. For example, the DU 165 may transmit the TDD pattern indication 310 in accordance with determining each parameter of the set of one or more parameters (e.g., based on expected traffic).

The quantity of slots 315 (e.g., numSlots) may indicate a duration for which the TDD pattern is applicable. In examples in which the quantity of slots 315 is a nonzero integer, the TDD pattern may be applicable for a quantity of slots (e.g., corresponding to the nonzero integer). That is, the quantity of slots 315 may indicate a slot duration associated with the TDD pattern. Alternatively, in examples in which the quantity of slots 315 is zero, the TDD pattern may be applicable until an updated TDD pattern is indicated. That is, the quantity of slots 315 may indicate that the TDD pattern is applicable indefinitely (e.g., until a new TDD pattern is received). As an example, the TDD pattern may be applicable until a second TDD pattern is transmitted by the DU 165 or received by the RU 170. That is, the second TDD pattern may override the TDD pattern in which the indicated quantity of slots 315 is zero (e.g., in which the TDD pattern is indefinitely applicable).

The pattern period 320 (e.g., PatternPeriod) may be a quantity of slots associated with a periodicity of the TDD pattern. For example, the TDD pattern may include a quantity of slots, where the TDD pattern is repeated after the quantity of slots. The quantity of slots associated with the periodicity of the TDD pattern may be less than the quantity of slots 315 (e.g., in examples in which the TDD pattern is applicable for a quantity of slots, rather than indefinitely). That is, the TDD pattern may be repeated one or more times during a same slot. The quantity of downlink slots 325 (e.g., numDLslots) and the quantity of uplink slots 330 (e.g., numULslots) may be quantities of consecutive downlink slots and consecutive uplink slots, respectively.

Values of the pattern period 320, the quantity of downlink slots 325, and the quantity of uplink slots 330 may be integer values of 0 through 80. For example, the pattern period 320, the quantity of downlink slots 325, and the quantity of uplink slots 330 may be equal to or less than a threshold quantity of slots in a frame (e.g., 80 slots). In some examples, the RU 170 may determine a quantity of special slots using the pattern period 320, the quantity of downlink slots 235, and the quantity of uplink slots 330. For example, the RU 170 may subtract a summation of the quantity of downlink slots 325 and the quantity of uplink slots 330 from the pattern period 320, where a difference between the summation and the pattern period 320 corresponds to the quantity of special slots in the TDD pattern. The special slots may be after, in time, the quantity of downlink slots 325 and before the quantity of uplink slots 330. That is, the RU 170 may assume that after the quantity of downlink slots 325 end, there will be a special slot. Additionally, a summation of the quantity of downlink slots 325, the quantity of uplink slots 330, and the quantity of special slots may be less than the threshold quantity of slots in the frame (e.g., 80 slots). That is, the TDD pattern including the quantity of downlink slots 325, the quantity of uplink slots 330, and the quantity of special slots may, at most, correspond to an entire frame. Alternatively, the TDD pattern may be repeated multiple times within the frame.

The quantity of downlink symbols 335 (e.g., numDLsymb) and the quantity of uplink symbols 340 (e.g., numULsymb) may be quantities of consecutive downlink symbols and consecutive uplink symbols, respectively, in a special slot. Values of the quantity of downlink symbols 335 and the quantity of uplink symbols 340 may be integer values of 0 through 14. For example, the quantity of downlink symbols 335 and the quantity of uplink symbols 340 may be equal to or less than a threshold quantity of symbols in a slot (e.g., 14 symbols). The RU 170 may determine a quantity of guard symbols using the quantity of downlink symbols 335 and the quantity of uplink symbols 340. For example, the RU 170 may subtract a summation of the quantity of downlink symbols 335 and the quantity of uplink symbols 340 from a total quantity of symbols in a slot (e.g., 14 symbols), where a difference between the summation and the total quantity corresponds to the quantity of guard symbols in the special slot. The guard symbols may be after, in time, the quantity of downlink symbols 335 and before the quantity of uplink symbols 340. That is, the RU 170 may assume that, within a special slot, after the quantity of downlink symbols 335 end, there will be guard symbols.

The pattern period 320, the quantity of downlink slots 325, the quantity of uplink slots 330, the quantity of downlink symbols 335, and the quantity of uplink symbols 340 may have a same parameter type. For example, the pattern period 320, the quantity of downlink slots 325, the quantity of uplink slots 330, the quantity of downlink symbols 335, and the quantity of uplink symbols 340 may be unsigned integers.

The TDD pattern indication 310 may indicate multiple TDD patterns. For example, the TDD pattern indication 310 may include the set of one or more parameters for multiple TDD patterns. The TDD pattern indication 310 may indicate the multiple TDD patterns in examples in which the DU 165, the RU 170, or both apply multiple TDD patterns in a same frame. In other words, the TDD pattern indication 310 may include multiple TDD patterns in examples in which the DU 165 and the RU 170 communicate in accordance with mixed TDD patterns within a frame. An exemplary structure of a TDD pattern indication 310 including sets of one or more parameters for multiple TDD patterns (e.g., N TDD patterns) is described with reference to Table 1 below.

TABLE 1

| | | | | | | | | | |
|---|---|---|---|---|---|---|---|---|---|
| 0 (msb) | 1 | 2 | 3 | 4 | 5 | 6 | 7 (isb) | Bytes | Octet |

| | | | |
|---|---|---|---|
| Reserved [1:0] | PatternPeriod1 [6:0] | 1 | 25 |
| Reserved [1:0] | numDLslots1 [6:0] | 1 | 26 |

| | | | |
|---|---|---|---|
| numDLsymb1 [3:0] | numULsymb1 [3:0] | 1 | 27 |

| | | | |
|---|---|---|---|
| Reserved [1:0] | numULslots1 [6:0] | 1 | 28 |
| Reserved [1:0] | PatternPeriod2 [6:0] | 1 | Var |
| Reserved [1:0] | numDLslots2 [6:0] | 1 | Var |

| | | | |
|---|---|---|---|
| numDLsymb2 [3:0] | numULsymb2 [3:0] | 1 | Var |

| Reserved [1:0] | numULslots2 [6:0] | 1 | Var |
|---|---|---|---|
| . . . | | | Var |
| . . . | | | |
| . . . | | | |
| . . . | | | Var |
| Reserved [1:0] | PatternPeriodN [6:0] | 1 | Var |
| Reserved [1:0] | numDLslotsN [6:0] | 1 | Var |

| | | | |
|---|---|---|---|
| numDLsymbN [3:0] | numULsymbN [3:0] | 1 | Var |

| | | | |
|---|---|---|---|
| Reserved [1:0] | numULslotsN [6:0] | 1 | Var |

As illustrated in the example of Table 1, the TDD pattern indication 310 may include multiple TDD patterns (e.g., N TDD patterns). The DU 165 and the RU 170 may communicate in accordance with the multiple TDD patterns. That is, the DU 165 and the RU 170 may apply the indicated TDD patterns in an order corresponding to the TDD pattern indication 310. That is, the DU 165 and the RU 170 may communicate in accordance with a first TDD pattern, a second TDD pattern, and so on until an Nth TDD pattern.

Table 2 below represents an example of the TDD pattern indication 310. For example, Table 2 may represent a section type command (e.g., a dynamic TDD indication section type command).

TABLE 2

| | | | | | | | | | |
|---|---|---|---|---|---|---|---|---|---|
| 0 (msb) | 1 | 2 | 3 | 4 | 5 | 6 | 7 (isb) | Bytes | Octet |

| | | | |
|---|---|---|---|
| Reserved [1:0] | PatternPeriod1 [6:0] = 10 | 1 | 25 |
| Reserved [1:0] | numDLslots1 [6:0] = 7 | 1 | 26 |

| | | | |
|---|---|---|---|
| numDLsymb1 [3:0] = 6 | numULsymb1 [3:0] = 4 | 1 | 27 |

| | | | |
|---|---|---|---|
| Reserved [1:0] | numULslots1 [6:0] = 2 | 1 | 28 |

In the example of Table 2, the DU 165 and the RU 170 may communicate in accordance with a subcarrier spacing of 15 kHz. The TDD pattern may include 7 downlink slots, 1 special slot, and 2 uplink slots (e.g., 7DS2U). The RU 170 may determine the quantity of special slots by calculating the pattern period 320 minus the quantity of downlink slots 325 and the quantity of uplink slots 330 (e.g., 10−(7+2)). The special slot of the TDD pattern may include 6 downlink symbols, 4 guard symbols, and 4 uplink symbols (e.g., 6D+4G+4U). The RU 170 may determine the quantity of guard symbols by calculating the total quantity of symbols in the slot minus the quantity of downlink symbols 335 and the quantity of uplink symbols 340 (e.g., 14−(6+4)).

Table 3 below represents an example of the TDD pattern indication 310. For example, Table 3 may represent a section type command (e.g., a dynamic TDD indication section type command).

TABLE 3

| | | | | | | | | | |
|---|---|---|---|---|---|---|---|---|---|
| 0 (msb) | 1 | 2 | 3 | 4 | 5 | 6 | 7 (isb) | Bytes | Octet |

| | | | |
|---|---|---|---|
| Reserved [1:0] | PatternPeriod1 [6:0] = 10 | 1 | 25 |
| Reserved [1:0] | numDLslots1 [6:0] = 1 | 1 | 26 |

| | | | |
|---|---|---|---|
| numDLsymb1 [3:0] = 10 | numULsymb1 [3:0] = 2 | 1 | 27 |

| | | | |
|---|---|---|---|
| Reserved [1:0] | numULslots1 [6:0] = 3 | 1 | 28 |
| Reserved [1:0] | PatternPeriod2 [6:0] = 10 | 1 | 29 |
| Reserved [1:0] | numDLslots2 [6:0] = 2 | 1 | 30 |

| | | | |
|---|---|---|---|
| numDLsymb2 [3:0] = 6 | numULsymb2 [3:0] = 4 | 1 | 31 |

| | | | |
|---|---|---|---|
| Reserved [1:0] | numULslots2 [6:0] = 2 | 1 | 32 |

In the example of Table 3, the DU 165 and the RU 170 may communicate in accordance with a subcarrier spacing of 30 kHz. Additionally, the TDD pattern indication 310 in the example of Table 3 may include two TDD patterns. A first TDD pattern may include 1 downlink slot, 6 special slots, and 3 uplink slots (e.g., DS₁UUU). A second TDD pattern may include 2 downlink slots, 6 special slots, and 2 uplink slots (e.g., DDS₂UU). The RU 170 may determine the quantity of special slots in the first TDD pattern and in the second TDD pattern by calculating the pattern period 320 minus the quantity of downlink slots 325 and the quantity of uplink slots 330. For example, the RU 170 may determine the quantity of special slots for the first TDD pattern as 10−(1+3)=6 special slots, and the RU 170 may determine the quantity of special slots for the second TDD pattern as 10−(2+2)=6 special slots. The special slots of the first TDD pattern may include 10 downlink symbols, 2 guard symbols, and 2 uplink symbols (e.g., 10D+2G+2U). The RU 170 may determine the quantity of guard symbols by calculating the total quantity of symbols in the slot minus the quantity of downlink symbols 335 and the quantity of uplink symbols 340 for the first TDD pattern (e.g., 14−(10+2)). The special slots of the second TDD pattern may include 6 downlink symbols, 4 guard symbols, and 4 uplink symbols (e.g., 6D+4G+4U). The RU 170 may determine the quantity of guard symbols by calculating the total quantity of symbols in the slot minus the quantity of downlink symbols 335 and the quantity of uplink symbols 340 for the second TDD pattern (e.g., 14−(6+4)).

Table 4 below represents an example of the TDD pattern indication 310. For example, Table 4 may represent a section type command (e.g., a dynamic TDD indication section type command).

TABLE 4

| | | | | | | | | | |
|---|---|---|---|---|---|---|---|---|---|
| 0 (msb) | 1 | 2 | 3 | 4 | 5 | 6 | 7 (isb) | Bytes | Octet |

| | | | |
|---|---|---|---|
| Reserved [1:0] | PatternPeriod1 [6:0] = 8 | 1 | 25 |
| Reserved [1:0] | numDLslots1 [6:0] = 4 | 1 | 26 |

| | | | |
|---|---|---|---|
| numDLsymb1 [3:0] = 10 | numULsymb1 [3:0] = 2 | 1 | 27 |

| | | | |
|---|---|---|---|
| Reserved [1:0] | numULslots1 [6:0] = 0 | 1 | 28 |
| Reserved [1:0] | PatternPeriod2 [6:0] = 8 | 1 | 29 |
| Reserved [1:0] | numDLslots2 [6:0] = 0 | 1 | 30 |

| | | | |
|---|---|---|---|
| numDLsymb2 [3:0] = 12 | numULsymb2 [3:0] = 0 | 1 | 31 |

| | | | |
|---|---|---|---|
| Reserved [1:0] | numULslots2 [6:0] = 2 | 1 | 32 |

In the example of Table 4, the DU 165 and the RU 170 may communicate in accordance with a subcarrier spacing of 120 kHz. Additionally, the TDD pattern indication 310 in the example of Table 4 may include two TDD patterns. A first TDD pattern may include 4 downlink slots, 4 special slots, and 0 uplink slots (e.g., DDDDS₁). A second TDD pattern may include 0 downlink slots, 6 special slots, and 2 uplink slots (e.g., S₂UU). The RU 170 may determine the quantity of special slots in the first TDD pattern and in the second TDD pattern by calculating the pattern period 320 minus the quantity of downlink slots 325 and the quantity of uplink slots 330. For example, the RU 170 may determine the quantity of special slots for the first TDD pattern as 8−(4+0)=4 special slots, and the RU 170 may determine the quantity of special slots for the second TDD pattern as 8−(0+2)=6 special slots. The special slots of the first TDD pattern may include 10 downlink symbols, 2 guard symbols, and 2 uplink symbols (e.g., 10D+2G+2U). The RU 170 may determine the quantity of guard symbols by calculating the total quantity of symbols in the slot minus the quantity of downlink symbols 335 and the quantity of uplink symbols 340 for the first TDD pattern (e.g., 14−(10+2)). The special slots of the second TDD pattern may include 12 downlink symbols, 2 guard symbols, and 0 uplink symbols (e.g., 6D+4G). The RU 170 may determine the quantity of guard symbols by calculating the total quantity of symbols in the slot minus the quantity of downlink symbols 335 and the quantity of uplink symbols 340 for the second TDD pattern (e.g., 14−(12+0)).

The DU 165 and the RU 170 may communicate downlink messages 345, uplink messages 350, or both according to the TDD pattern indication 310. That is, the DU 165 may output the downlink messages 345 during the quantity of downlink slots 325, during the quantity of downlink symbols 335 in one or more special slots, or both. Additionally, or alternatively, the RU 170 may output the uplink messages 350 during the quantity of uplink slots 330, during the quantity of uplink symbols 340 in the one or more special slots, or both.

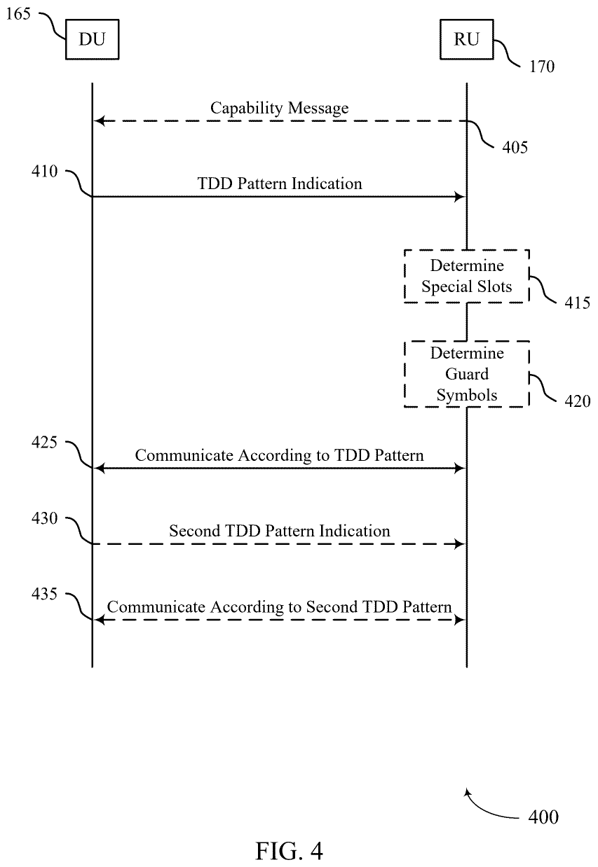

FIG. 4 shows an example of a process flow 400 that supports ORAN split dynamic TDD scheduling in accordance with one or more aspects of the present disclosure. The process flow 400 may implement or be implemented by aspects of the wireless communications system 100, the network architecture 200, the wireless communications system 300, or any combination thereof as described with reference to FIGS. 1 through 3. For example, the process flow 400 may include a DU 165 and an RU 170, which may be examples of corresponding devices as described with reference to FIGS. 2 and 3.

Alternative examples of the following may be implemented, where some operations are performed in a different order than described or are not performed at all. In some cases, operations may include additional features not mentioned below, or further operations may be added. Although the DU 165 and the RU 170 are shown performing the operations of the process flow 400, some aspects of some operations may also be performed by one or more other wireless devices.

At 405, the RU 170 may transmit a capability message to the DU 165. For example, the RU 170 may transmit a capability message indicative of a capability of the RU 170 to receive an indication of the TDD pattern. The capability message may be an example of the capability message 305 as described with reference to FIG. 3. For example, the capability message 305 may include a field corresponding to a capability to receive the indication of the TDD pattern, where a value of ‘true’ in the field indicates that the RU 170 has the capability and a value of ‘false’ in the field indicates that the RU 170 does not have the capability.

At 410, the DU 165 may transmit a TDD pattern indication to the RU 170. For example, the RU 170 may receive, at a start of a frame and from the DU 165, an indication of a TDD pattern for a quantity of slots. The TDD pattern may include the quantity of slots, a pattern period, a quantity of downlink slots, a quantity of uplink slots, a quantity of uplink symbols, and a quantity of downlink symbols. The TDD pattern indication may be an example of the TDD pattern indication 310, and the quantity of slots, the pattern period, the quantity of downlink slots, the quantity of uplink slots, the quantity of uplink symbols, and the quantity of downlink symbols may be examples of corresponding parameters as described with reference to FIG. 3.

In some examples, the quantity of slots may include a nonzero integer quantity of slots for which the TDD pattern is applicable. That is, in examples in which the parameter quantity of slots includes a non-zero integer, the DU 165, the RU 170, or both may communicate in accordance with the TDD pattern for a quantity of slots corresponding to the non-zero integer. Alternatively, the quantity of slots may be zero, and the DU 165, the RU 170, or both may communicate in accordance with the TDD pattern until an updated TDD pattern is received (e.g., indefinitely).

The pattern period may be indicative of a second quantity of slots associated with a periodicity of the TDD pattern, where the TDD pattern is repeated after the second quantity of slots. Additionally, the quantity of downlink slots may include a quantity of consecutive downlink slots, and the quantity of uplink slots may include a quantity of consecutive uplink slots. In some examples, the quantity of downlink symbols may include a quantity of consecutive downlink symbols in one or more special slots of the TDD pattern, and the quantity of uplink symbols may include a quantity of consecutive uplink symbols in the one or more special slots of the TDD pattern.

At 415, the RU 170 may determine the special slots. For example, the RU 170 may determine one or more special slots using the quantity of downlink slots and the quantity of uplink slots. That is, the RU 170 may subtract the quantity of downlink slots and the quantity of uplink slots from the second quantity of slots in the pattern period to determine the one or more special slots. The one or more special slots may be after the quantity of downlink slots and before the quantity of uplink slots in time. Additionally, or alternatively, communicating with the DU 165 may be in accordance with the one or more special slots.

At 420, the RU 170 may determine guard symbols. For example, the RU 170 may determine one or more guard symbols using the quantity of downlink symbols and the quantity of uplink symbols. That is, the RU 170 may subtract the quantity of downlink symbols and the quantity of uplink symbols from a quantity of symbols in a slot to determine the one or more guard symbols. The one or more guard symbols may be after the quantity of downlink symbols and before the quantity of uplink symbols in time. Additionally, or alternatively, communicating with the DU 165 may be in accordance with the one or more guard symbols.

At 425, the DU 165 and the RU 170 may communicate in accordance with the TDD pattern. For example, the DU 165 and the RU 170 may communicate one or more downlink messages, one or more uplink messages, or both during one or more slots of the frame in accordance with the TDD pattern.

At 430, the DU 165 may transmit a second TDD pattern indication to the RU 170. The DU 165 may transmit the second TDD pattern indication after the quantity of slots for which the TDD pattern (e.g., indicated at 410) was applicable. For example, the DU 165 may transmit the second TDD pattern indication after the quantity of slots in examples in which the TDD pattern is applicable for the non-zero integer quantity of slots. Alternatively, the DU 165 may transmit the second TDD pattern indication to override or update the TDD pattern indicated at 410. For example, the DU 165 may transmit the second TDD pattern indication that replaces the TDD pattern indicated at 410 in examples in which the TDD pattern is applicable until an updated TDD pattern is received (e.g., indefinitely). At 435, after communicating the second TDD pattern indication, the DU 165 and the RU 170 may communicate in accordance with the second TDD pattern. That is, the DU 165 and the RU 170 may communicate during one or more second slots in accordance with the second TDD pattern, where the second TDD pattern replaces the TDD pattern.

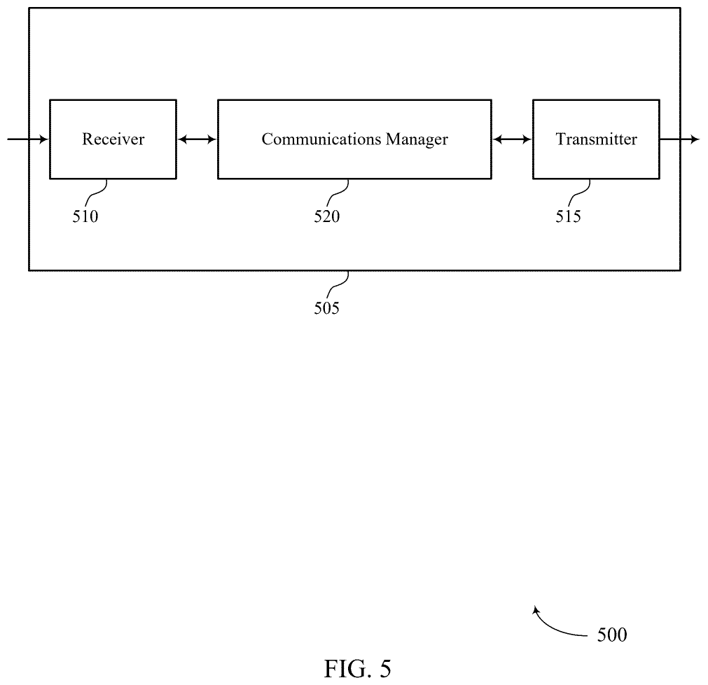

FIG. 5 shows a block diagram 500 of a device 505 that supports ORAN split dynamic TDD scheduling in accordance with one or more aspects of the present disclosure. The device 505 may be an example of aspects of a network entity 105 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to, individually or collectively, support or enable the described techniques. Each of these components may be in communication with one another (e.g., via one or more buses).

The receiver 510 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 505. In some examples, the receiver 510 may support obtaining information by receiving signals via one or more antennas. Additionally, or alternatively, the receiver 510 may support obtaining information by receiving signals via one or more wired (e.g., electrical, fiber optic) interfaces, wireless interfaces, or any combination thereof.

The transmitter 515 may provide a means for outputting (e.g., transmitting, providing, conveying, sending) information generated by other components of the device 505. For example, the transmitter 515 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 515 may support outputting information by transmitting signals via one or more antennas. Additionally, or alternatively, the transmitter 515 may support outputting information by transmitting signals via one or more wired (e.g., electrical, fiber optic) interfaces, wireless interfaces, or any combination thereof. In some examples, the transmitter 515 and the receiver 510 may be co-located in a transceiver, which may include or be coupled with a modem.

The communications manager 520, the receiver 510, the transmitter 515, or various combinations or components thereof may be examples of means for performing various aspects of ORAN split dynamic TDD scheduling as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor (e.g., referred to as a processor-executable code). If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for receiving, at a start of a frame and from a distributed unit (DU), an indication of a TDD pattern for a quantity of slots, the TDD pattern including the quantity of slots, a pattern period, a quantity of downlink slots, a quantity of uplink slots, a quantity of uplink symbols, and a quantity of downlink symbols. The communications manager 520 is capable of, configured to, or operable to support a means for communicating one or more downlink messages, one or more uplink messages, or both during one or more slots of the frame in accordance with the TDD pattern.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for reduced processing and more efficient utilization of communication resources.

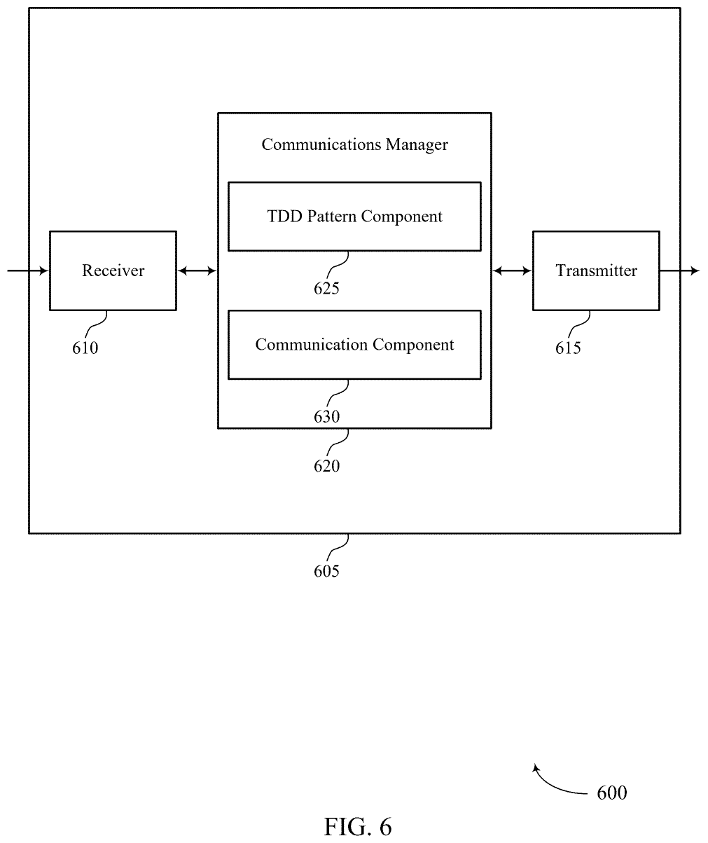

FIG. 6 shows a block diagram 600 of a device 605 that supports ORAN split dynamic TDD scheduling in accordance with one or more aspects of the present disclosure. The device 605 may be an example of aspects of a device 505 or a network entity 105 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to support the described techniques. Each of these components may be in communication with one another (e.g., via one or more buses).

The receiver 610 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 605. In some examples, the receiver 610 may support obtaining information by receiving signals via one or more antennas. Additionally, or alternatively, the receiver 610 may support obtaining information by receiving signals via one or more wired (e.g., electrical, fiber optic) interfaces, wireless interfaces, or any combination thereof.

The transmitter 615 may provide a means for outputting (e.g., transmitting, providing, conveying, sending) information generated by other components of the device 605. For example, the transmitter 615 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 615 may support outputting information by transmitting signals via one or more antennas. Additionally, or alternatively, the transmitter 615 may support outputting information by transmitting signals via one or more wired (e.g., electrical, fiber optic) interfaces, wireless interfaces, or any combination thereof. In some examples, the transmitter 615 and the receiver 610 may be co-located in a transceiver, which may include or be coupled with a modem.

The device 605, or various components thereof, may be an example of means for performing various aspects of ORAN split dynamic TDD scheduling as described herein. For example, the communications manager 620 may include a TDD pattern component 625 a communication component 630, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The TDD pattern component 625 is capable of, configured to, or operable to support a means for receiving, at a start of a frame and from a distributed unit (DU), an indication of a TDD pattern for a quantity of slots, the TDD pattern including the quantity of slots, a pattern period, a quantity of downlink slots, a quantity of uplink slots, a quantity of uplink symbols, and a quantity of downlink symbols. The communication component 630 is capable of, configured to, or operable to support a means for communicating one or more downlink messages, one or more uplink messages, or both during one or more slots of the frame in accordance with the TDD pattern.

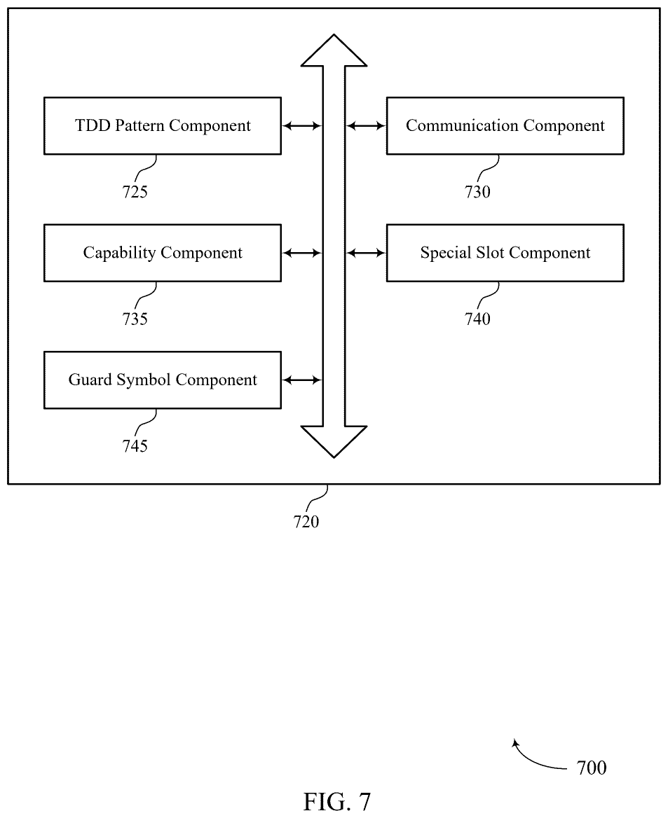

FIG. 7 shows a block diagram 700 of a communications manager 720 that supports ORAN split dynamic TDD scheduling in accordance with one or more aspects of the present disclosure. The communications manager 720 may be an example of aspects of a communications manager 520, a communications manager 620, or both, as described herein. The communications manager 720, or various components thereof, may be an example of means for performing various aspects of ORAN split dynamic TDD scheduling as described herein. For example, the communications manager 720 may include a TDD pattern component 725, a communication component 730, a capability component 735, a special slot component 740, a guard symbol component 745, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 720 may support wireless communications in accordance with examples as disclosed herein. The TDD pattern component 725 is capable of, configured to, or operable to support a means for receiving, at a start of a frame and from a distributed unit (DU), an indication of a TDD pattern for a quantity of slots, the TDD pattern including the quantity of slots, a pattern period, a quantity of downlink slots, a quantity of uplink slots, a quantity of uplink symbols, and a quantity of downlink symbols. The communication component 730 is capable of, configured to, or operable to support a means for communicating one or more downlink messages, one or more uplink messages, or both during one or more slots of the frame in accordance with the TDD pattern.

In some examples, the capability component 735 is capable of, configured to, or operable to support a means for transmitting a capability message indicative of a capability of the RU to receive the indication of the TDD pattern, where receiving the indication of the TDD pattern is in accordance with transmitting the capability message.

In some examples, the quantity of slots includes a non-zero integer quantity of slots for which the TDD pattern is applicable.

In some examples, the quantity of slots is zero. In some examples, the RU communicates in accordance with the TDD pattern until an updated TDD pattern is received.

In some examples, the TDD pattern component 725 is capable of, configured to, or operable to support a means for receiving a second indication of a second TDD pattern for a second quantity of slots. In some examples, the communication component 730 is capable of, configured to, or operable to support a means for communicating during one or more second slots in accordance with the second TDD pattern, where the second TDD pattern replaces the TDD pattern.

In some examples, the pattern period is indicative of a second quantity of slots associated with a periodicity of the TDD pattern. In some examples, the TDD pattern is repeated after the second quantity of slots.

In some examples, the quantity of downlink slots includes a quantity of consecutive downlink slots. In some examples, the quantity of uplink slots includes a quantity of consecutive uplink slots.

In some examples, the quantity of downlink symbols includes a quantity of consecutive downlink symbols in one or more special slots of the TDD pattern. In some examples, the quantity of uplink symbols includes a quantity of consecutive uplink symbols in the one or more special slots of the TDD pattern.

In some examples, the special slot component 740 is capable of, configured to, or operable to support a means for determining one or more special slots using the quantity of downlink slots and the quantity of uplink slots, where: the one or more special slots are after the quantity of downlink slots and before the quantity of uplink slots in time; and the communicating is in accordance with the one or more special slots.

In some examples, the guard symbol component 745 is capable of, configured to, or operable to support a means for determining one or more guard symbols using the quantity of downlink symbols and the quantity of uplink symbols, where: the one or more guard symbols are after the quantity of downlink symbols and before the quantity of uplink symbols in time; and the communicating is in accordance with the one or more guard symbols.

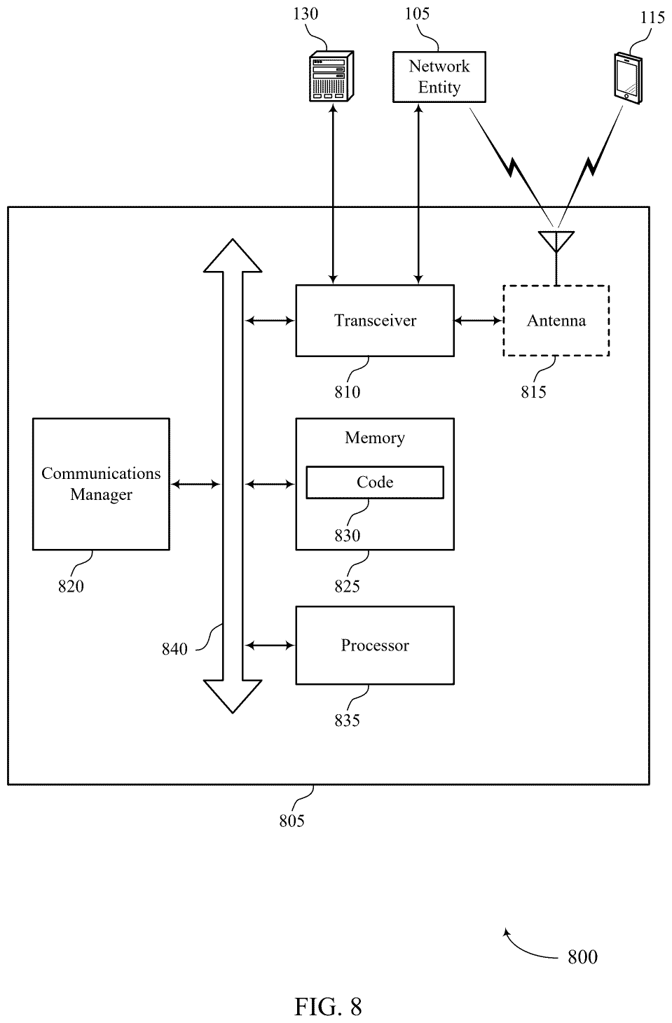

FIG. 8 shows a diagram of a system 800 including a device 805 that supports ORAN split dynamic TDD scheduling in accordance with one or more aspects of the present disclosure. The device 805 may be an example of or include components of a device 505, a device 605, or a network entity 105 as described herein. The device 805 may communicate with other network devices or network equipment such as one or more of the network entities 105, UEs 115, or any combination thereof. The communications may include communications over one or more wired interfaces, over one or more wireless interfaces, or any combination thereof. The device 805 may include components that support outputting and obtaining communications, such as a communications manager 820, a transceiver 810, one or more antennas 815, at least one memory 825, code 830, and at least one processor 835. These components may be in electronic communication or otherwise coupled (e.g., operatively, communicatively, functionally, electronically, electrically) via one or more buses (e.g., a bus 840).

The transceiver 810 may support bi-directional communications via wired links, wireless links, or both as described herein. In some examples, the transceiver 810 may include a wired transceiver and may communicate bi-directionally with another wired transceiver. Additionally, or alternatively, in some examples, the transceiver 810 may include a wireless transceiver and may communicate bi-directionally with another wireless transceiver. In some examples, the device 805 may include one or more antennas 815, which may be capable of transmitting or receiving wireless transmissions (e.g., concurrently). The transceiver 810 may also include a modem to modulate signals, to provide the modulated signals for transmission (e.g., by one or more antennas 815, by a wired transmitter), to receive modulated signals (e.g., from one or more antennas 815, from a wired receiver), and to demodulate signals. In some implementations, the transceiver 810 may include one or more interfaces, such as one or more interfaces coupled with the one or more antennas 815 that are configured to support various receiving or obtaining operations, or one or more interfaces coupled with the one or more antennas 815 that are configured to support various transmitting or outputting operations, or a combination thereof. In some implementations, the transceiver 810 may include or be configured for coupling with one or more processors or one or more memory components that are operable to perform or support operations based on received or obtained information or signals, or to generate information or other signals for transmission or other outputting, or any combination thereof. In some implementations, the transceiver 810, or the transceiver 810 and the one or more antennas 815, or the transceiver 810 and the one or more antennas 815 and one or more processors or one or more memory components (e.g., the at least one processor 835, the at least one memory 825, or both), may be included in a chip or chip assembly that is installed in the device 805. In some examples, the transceiver 810 may be operable to support communications via one or more communications links (e.g., communication link(s) 125, backhaul communication link(s) 120, a midhaul communication link 162, a fronthaul communication link 168).

The at least one memory 825 may include RAM, ROM, or any combination thereof. The at least one memory 825 may store computer-readable, computer-executable, or processor-executable code, such as the code 830. The code 830 may include instructions that, when executed by one or more of the at least one processor 835, cause the device 805 to perform various functions described herein. The code 830 may be stored in a non-transitory computer-readable medium such as system memory or another type of memory. In some cases, the code 830 may not be directly executable by a processor of the at least one processor 835 but may cause a computer (e.g., when compiled and executed) to perform functions described herein. In some cases, the at least one memory 825 may include, among other things, a BIOS which may control basic hardware or software operation such as the interaction with peripheral components or devices. In some examples, the at least one processor 835 may include multiple processors and the at least one memory 825 may include multiple memories. One or more of the multiple processors may be coupled with one or more of the multiple memories which may, individually or collectively, be configured to perform various functions herein (for example, as part of a processing system).

The at least one processor 835 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 835 may be configured to operate a memory array using a memory controller. In some other cases, a memory controller may be integrated into one or more of the at least one processor 835. The at least one processor 835 may be configured to execute computer-readable instructions stored in a memory (e.g., one or more of the at least one memory 825) to cause the device 805 to perform various functions (e.g., functions or tasks supporting ORAN split dynamic TDD scheduling). For example, the device 805 or a component of the device 805 may include at least one processor 835 and at least one memory 825 coupled with one or more of the at least one processor 835, the at least one processor 835 and the at least one memory 825 configured to perform various functions described herein. The at least one processor 835 may be an example of a cloud-computing platform (e.g., one or more physical nodes and supporting software such as operating systems, virtual machines, or container instances) that may host the functions (e.g., by executing code 830) to perform the functions of the device 805. The at least one processor 835 may be any one or more suitable processors capable of executing scripts or instructions of one or more software programs stored in the device 805 (such as within one or more of the at least one memory 825).

In some examples, the at least one processor 835 may include multiple processors and the at least one memory 825 may include multiple memories. One or more of the multiple processors may be coupled with one or more of the multiple memories, which may, individually or collectively, be configured to perform various functions herein. In some examples, the at least one processor 835 may be a component of a processing system, which may refer to a system (such as a series) of machines, circuitry (including, for example, one or both of processor circuitry (which may include the at least one processor 835) and memory circuitry (which may include the at least one memory 825)), or components, that receives or obtains inputs and processes the inputs to produce, generate, or obtain a set of outputs. The processing system may be configured to perform one or more of the functions described herein. For example, the at least one processor 835 or a processing system including the at least one processor 835 may be configured to, configurable to, or operable to cause the device 805 to perform one or more of the functions described herein. Further, as described herein, being “configured to,” being “configurable to,” and being “operable to” may be used interchangeably and may be associated with a capability, when executing code stored in the at least one memory 825 or otherwise, to perform one or more of the functions described herein.

In some examples, a bus 840 may support communications of (e.g., within) a protocol layer of a protocol stack. In some examples, a bus 840 may support communications associated with a logical channel of a protocol stack (e.g., between protocol layers of a protocol stack), which may include communications performed within a component of the device 805, or between different components of the device 805 that may be co-located or located in different locations (e.g., where the device 805 may refer to a system in which one or more of the communications manager 820, the transceiver 810, the at least one memory 825, the code 830, and the at least one processor 835 may be located in one of the different components or divided between different components).

In some examples, the communications manager 820 may manage aspects of communications with a core network 130 (e.g., via one or more wired or wireless backhaul links). For example, the communications manager 820 may manage the transfer of data communications for client devices, such as one or more UEs 115. In some examples, the communications manager 820 may manage communications with one or more other network entities 105, and may include a controller or scheduler for controlling communications with UEs 115 (e.g., in cooperation with the one or more other network devices). In some examples, the communications manager 820 may support an X2 interface within an LTE/LTE-A wireless communications network technology to provide communication between network entities 105.

The communications manager 820 may support wireless communications in accordance with examples as disclosed herein. For example, the communications manager 820 is capable of, configured to, or operable to support a means for receiving, at a start of a frame and from a distributed unit (DU), an indication of a TDD pattern for a quantity of slots, the TDD pattern including the quantity of slots, a pattern period, a quantity of downlink slots, a quantity of uplink slots, a quantity of uplink symbols, and a quantity of downlink symbols. The communications manager 820 is capable of, configured to, or operable to support a means for communicating one or more downlink messages, one or more uplink messages, or both during one or more slots of the frame in accordance with the TDD pattern.

By including or configuring the communications manager 820 in accordance with examples as described herein, the device 805 may support techniques for improved user experience related to reduced processing, more efficient utilization of communication resources, and improved coordination between devices.

In some examples, the communications manager 820 may be configured to perform various operations (e.g., receiving, obtaining, monitoring, outputting, transmitting) using or otherwise in cooperation with the transceiver 810, the one or more antennas 815 (e.g., where applicable), or any combination thereof. Although the communications manager 820 is illustrated as a separate component, in some examples, one or more functions described with reference to the communications manager 820 may be supported by or performed by the transceiver 810, one or more of the at least one processor 835, one or more of the at least one memory 825, the code 830, or any combination thereof (for example, by a processing system including at least a portion of the at least one processor 835, the at least one memory 825, the code 830, or any combination thereof). For example, the code 830 may include instructions executable by one or more of the at least one processor 835 to cause the device 805 to perform various aspects of ORAN split dynamic TDD scheduling as described herein, or the at least one processor 835 and the at least one memory 825 may be otherwise configured to, individually or collectively, perform or support such operations.

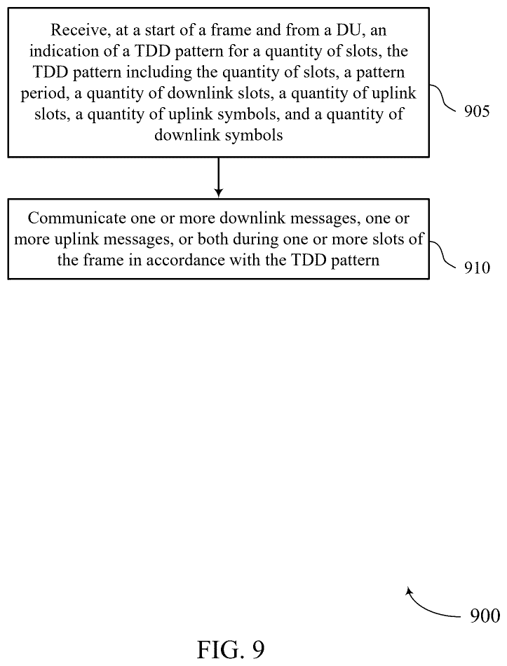

FIG. 9 shows a flowchart illustrating a method 900 that supports ORAN split dynamic TDD scheduling in accordance with one or more aspects of the present disclosure. The operations of the method 900 may be implemented by a network entity or its components as described herein. For example, the operations of the method 900 may be performed by a network entity as described with reference to FIGS. 1 through 8. In some examples, a network entity may execute a set of instructions to control the functional elements of the network entity to perform the described functions. Additionally, or alternatively, the network entity may perform aspects of the described functions using special-purpose hardware.

At 905, the method may include receiving, at a start of a frame and from a distributed unit (DU), an indication of a TDD pattern for a quantity of slots, the TDD pattern including the quantity of slots, a pattern period, a quantity of downlink slots, a quantity of uplink slots, a quantity of uplink symbols, and a quantity of downlink symbols. The operations of 905 may be performed in accordance with examples as disclosed herein. In some examples, aspects of the operations of 905 may be performed by a TDD pattern component 725 as described with reference to FIG. 7.

At 910, the method may include communicating one or more downlink messages, one or more uplink messages, or both during one or more slots of the frame in accordance with the TDD pattern. The operations of 910 may be performed in accordance with examples as disclosed herein. In some examples, aspects of the operations of 910 may be performed by a communication component 730 as described with reference to FIG. 7.

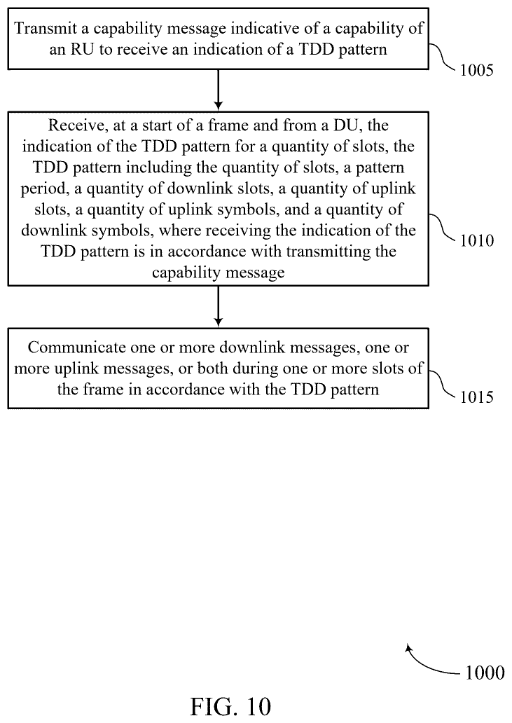

FIG. 10 shows a flowchart illustrating a method 1000 that supports ORAN split dynamic TDD scheduling in accordance with one or more aspects of the present disclosure. The operations of the method 1000 may be implemented by a network entity or its components as described herein. For example, the operations of the method 1000 may be performed by a network entity as described with reference to FIGS. 1 through 8. In some examples, a network entity may execute a set of instructions to control the functional elements of the network entity to perform the described functions. Additionally, or alternatively, the network entity may perform aspects of the described functions using special-purpose hardware.

At 1005, the method may include transmitting a capability message indicative of a capability of the RU to receive the indication of the TDD pattern. The operations of 1005 may be performed in accordance with examples as disclosed herein. In some examples, aspects of the operations of 1005 may be performed by a capability component 735 as described with reference to FIG. 7.

At 1010, the method may include receiving, at a start of a frame and from a distributed unit (DU), an indication of a TDD pattern for a quantity of slots, the TDD pattern including the quantity of slots, a pattern period, a quantity of downlink slots, a quantity of uplink slots, a quantity of uplink symbols, and a quantity of downlink symbols, where receiving the indication of the TDD pattern is in accordance with transmitting the capability message. The operations of 1010 may be performed in accordance with examples as disclosed herein. In some examples, aspects of the operations of 1010 may be performed by a TDD pattern component 725 as described with reference to FIG. 7.

At 1015, the method may include communicating one or more downlink messages, one or more uplink messages, or both during one or more slots of the frame in accordance with the TDD pattern. The operations of 1015 may be performed in accordance with examples as disclosed herein. In some examples, aspects of the operations of 1015 may be performed by a communication component 730 as described with reference to FIG. 7.

The following provides an overview of aspects of the present disclosure:
Aspect 1: A method for wireless communications by an RU, comprising: receiving, at a start of a frame and from a DU, an indication of a TDD pattern for a quantity of slots, the TDD pattern comprising the quantity of slots, a pattern period, a quantity of downlink slots, a quantity of uplink slots, a quantity of uplink symbols, and a quantity of downlink symbols; and communicating one or more downlink messages, one or more uplink messages, or both during one or more slots of the frame in accordance with the TDD pattern.
Aspect 2: The method of aspect 1, further comprising: transmitting a capability message indicative of a capability of the RU to receive the indication of the TDD pattern, wherein receiving the indication of the TDD pattern is in accordance with transmitting the capability message.
Aspect 3: The method of any of aspects 1 through 2, wherein the quantity of slots comprises a non-zero integer quantity of slots for which the TDD pattern is applicable.
Aspect 4: The method of any of aspects 1 through 3, wherein the quantity of slots is zero, and the RU communicates in accordance with the TDD pattern until an updated TDD pattern is received.
Aspect 5: The method of aspect 4, further comprising: receiving a second indication of a second TDD pattern for a second quantity of slots; and communicating during one or more second slots in accordance with the second TDD pattern, wherein the second TDD pattern replaces the TDD pattern.
Aspect 6: The method of any of aspects 1 through 5, wherein the pattern period is indicative of a second quantity of slots associated with a periodicity of the TDD pattern, and the TDD pattern is repeated after the second quantity of slots.
Aspect 7: The method of any of aspects 1 through 6, wherein the quantity of downlink slots comprises a quantity of consecutive downlink slots, and the quantity of uplink slots comprises a quantity of consecutive uplink slots.
Aspect 8: The method of any of aspects 1 through 7, wherein the quantity of downlink symbols comprises a quantity of consecutive downlink symbols in one or more special slots of the TDD pattern, and the quantity of uplink symbols comprises a quantity of consecutive uplink symbols in the one or more special slots of the TDD pattern.
Aspect 9: The method of any of aspects 1 through 8, further comprising: determining one or more special slots using the quantity of downlink slots and the quantity of uplink slots, wherein: the one or more special slots are after the quantity of downlink slots and before the quantity of uplink slots in time; and communicating with the UE is in accordance with the quantity of special slots.
Aspect 10: The method of any of aspects 1 through 9, further comprising: determining one or more guard symbols using the quantity of downlink symbols and the quantity of uplink symbols, wherein: the one or more guard symbols are after the quantity of downlink symbols and before the quantity of uplink symbols in time; and communicating with the UE is in accordance with the quantity of guard symbols.
Aspect 11: An RU for wireless communications, comprising one or more memories storing processor-executable code, and one or more processors coupled with the one or more memories and individually or collectively operable to execute the code to cause the RU to perform a method of any of aspects 1 through 10.
Aspect 12: An RU for wireless communications, comprising at least one means for performing a method of any of aspects 1 through 10.
Aspect 13: A non-transitory computer-readable medium storing code for wireless communications, the code comprising instructions executable by one or more processors to perform a method of any of aspects 1 through 10.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.” Also, as used herein, the phrase “a set” shall be construed as including the possibility of a set with one member. That is, the phrase “a set” shall be construed in the same manner as “one or more.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A radio unit (RU), comprising:
one or more memories storing processor-executable code; and
one or more processors coupled with the one or more memories and individually or collectively operable to execute the code to cause the RU to:
receive, at a start of a frame and from a distributed unit (DU), an indication of a time division duplexing (TDD) pattern for a quantity of slots, the TDD pattern comprising the quantity of slots, a pattern period, a quantity of downlink slots, a quantity of uplink slots, a quantity of uplink symbols, and a quantity of downlink symbols; and
communicate one or more downlink messages, one or more uplink messages, or both during one or more slots of the frame in accordance with the TDD pattern.

2. The RU of claim 1, wherein the one or more processors are individually or collectively further operable to execute the code to cause the RU to:
transmit a capability message indicative of a capability of the RU to receive the indication of the TDD pattern, wherein receiving the indication of the TDD pattern is in accordance with transmitting the capability message.

3. The RU of claim 1, wherein the quantity of slots comprises a non-zero integer quantity of slots for which the TDD pattern is applicable.

4. The RU of claim 1, wherein the quantity of slots is zero, and the RU communicates in accordance with the TDD pattern until an updated TDD pattern is received.

5. The RU of claim 4, wherein the one or more processors are individually or collectively further operable to execute the code to cause the RU to:
receive a second indication of a second TDD pattern for a second quantity of slots; and
communicate during one or more second slots in accordance with the second TDD pattern, wherein the second TDD pattern replaces the TDD pattern.

6. The RU of claim 1, wherein the pattern period is indicative of a second quantity of slots associated with a periodicity of the TDD pattern, and the TDD pattern is repeated after the second quantity of slots.

7. The RU of claim 1, wherein the quantity of downlink slots comprises a quantity of consecutive downlink slots, and the quantity of uplink slots comprises a quantity of consecutive uplink slots.

8. The RU of claim 1, wherein the quantity of downlink symbols comprises a quantity of consecutive downlink symbols in one or more special slots of the TDD pattern, and the quantity of uplink symbols comprises a quantity of consecutive uplink symbols in the one or more special slots of the TDD pattern.

9. The RU of claim 1, wherein the one or more processors are individually or collectively further operable to execute the code to cause the RU to:
determine one or more special slots using the quantity of downlink slots and the quantity of uplink slots, wherein:
the one or more special slots are after the quantity of downlink slots and before the quantity of uplink slots in time; and
the communicating is in accordance with the one or more special slots.

10. The RU of claim 1, wherein the one or more processors are individually or collectively further operable to execute the code to cause the RU to:
determine one or more guard symbols using the quantity of downlink symbols and the quantity of uplink symbols, wherein:
the one or more guard symbols are after the quantity of downlink symbols and before the quantity of uplink symbols in time; and
the communicating is in accordance with the one or more guard symbols.

11. A method for wireless communications by a radio unit (RU), comprising:
receiving, at a start of a frame and from a distributed unit (DU), an indication of a time division duplexing (TDD) pattern for a quantity of slots, the TDD pattern comprising the quantity of slots, a pattern period, a quantity of downlink slots, a quantity of uplink slots, a quantity of uplink symbols, and a quantity of downlink symbols; and
communicating one or more downlink messages, one or more uplink messages, or both during one or more slots of the frame in accordance with the TDD pattern.

12. The method of claim 11, further comprising:
transmitting a capability message indicative of a capability of the RU to receive the indication of the TDD pattern, wherein receiving the indication of the TDD pattern is in accordance with transmitting the capability message.

13. The method of claim 11, wherein the quantity of slots comprises a non-zero integer quantity of slots for which the TDD pattern is applicable.

14. The method of claim 11, wherein the quantity of slots is zero, and the RU communicates in accordance with the TDD pattern until an updated TDD pattern is received.

15. The method of claim 14, further comprising:
receiving a second indication of a second TDD pattern for a second quantity of slots; and
communicating during one or more second slots in accordance with the second TDD pattern, wherein the second TDD pattern replaces the TDD pattern.

16. The method of claim 11, wherein the pattern period is indicative of a second quantity of slots associated with a periodicity of the TDD pattern, and the TDD pattern is repeated after the second quantity of slots.

17. The method of claim 11, wherein the quantity of downlink slots comprises a quantity of consecutive downlink slots, and the quantity of uplink slots comprises a quantity of consecutive uplink slots.

18. The method of claim 11, wherein the quantity of downlink symbols comprises a quantity of consecutive downlink symbols in one or more special slots of the TDD pattern, and the quantity of uplink symbols comprises a quantity of consecutive uplink symbols in the one or more special slots of the TDD pattern.

19. The method of claim 11, further comprising:
determining one or more special slots using the quantity of downlink slots and the quantity of uplink slots, wherein:
the one or more special slots are after the quantity of downlink slots and before the quantity of uplink slots in time; and
the communicating is in accordance with the one or more special slots.

20. A non-transitory computer-readable medium storing code for wireless communications, the code comprising instructions executable by one or more processors to:
receive, at a start of a frame and from a distributed unit (DU), an indication of a time division duplexing (TDD) pattern for a quantity of slots, the TDD pattern comprising the quantity of slots, a pattern period, a quantity of downlink slots, a quantity of uplink slots, a quantity of uplink symbols, and a quantity of downlink symbols; and
communicate one or more downlink messages, one or more uplink messages, or both during one or more slots of the frame in accordance with the TDD pattern.
